(19) United States
(12) Patent Application Publication
(10) Pub. No.: US 2011/0213550 A1
(43) Pub. Date: Sep. 1, 2011

(54) NAVIGATION SYSTEM

(75) Inventor: Yoshiji ISHIZUKA, Kobe-shi (JP)

(73) Assignee: FUJITSU TEN LIMITED, Kobe-shi (JP)

(21) Appl. No.: 13/012,330

(22) Filed: Jan. 24, 2011

(30) Foreign Application Priority Data
Feb. 26, 2010 (JP) 2010-042543

(51) Int. Cl. G01C 21/00

(52) U.S. Cl. 701/201; 701/200

(57) ABSTRACT

A data providing apparatus included in a navigation system obtains, from the in-vehicle apparatus, first direction data which represents a direction in which the vehicle heads at a start of providing the navigation data and derives second direction data which represents the direction in which the vehicle heads based on a change of a location of the vehicle after a start of traveling of the vehicle. The data providing apparatus transmits, to the in-vehicle apparatus, the navigation data in accordance with the direction in which the vehicle heads and transmits, to the in-vehicle apparatus, the second direction data which is derived. The in-vehicle apparatus included in the navigation system displays the navigation data which is received from the data providing apparatus, and the in-vehicle apparatus stores, during a stop of working of the in-vehicle apparatus, the second direction data received from the data providing apparatus. Then the in-vehicle apparatus transmits the second direction data which is stored, to the data providing apparatus as the first direction data after activation of the in-vehicle apparatus.

### BACKGROUND OF THE INVENTION

1. Field of the Invention

This invention relates to a technology that implements a navigation function by providing navigation data from a data providing apparatus to an in-vehicle apparatus for installation in a vehicle.

2. Description of the Background Art

One of well-known technologies is a navigation system which computes current location data representing a location (on the earth) of the vehicle in which the navigation system is installed, using Global Positioning System (GPS), and then which displays a guidance image on a display of an in-vehicle apparatus in the vehicle based on the current location.

The in-vehicle apparatus is installed in a vehicle, such as a car. The current location data is computed based on radio waves which the in-vehicle apparatus receives from three or more GPS satellites. A method of displaying a guidance image and a vehicle location mark representing a location of the vehicle is explained. First, the in-vehicle apparatus displays the vehicle location mark fixed at a predetermined location on the guidance image. Recognizing the vehicle location mark as a current location of the vehicle, the in-vehicle apparatus updates and displays the guidance image according to the location data which changes with the travel of the vehicle.

In other words, by updating and displaying of a map showing the vicinity of the vehicle according to the travel of the vehicle, the in-vehicle apparatus displays the vehicle location mark as if the vehicle location mark was moving. Moreover, the vehicle location mark also indicates a direction in which the vehicle heads on the guidance image.

The in-vehicle apparatus determines the direction in which the vehicle heads, by deriving a track of the vehicle based on data about the current location and/or data transmitted from a gyroscope, and further deriving the traveling direction of the vehicle from the track derived.

As a result, the in-vehicle apparatus is incapable of determining the direction in which the vehicle heads until the vehicle travels a certain distance. The in-vehicle apparatus cannot determine the direction when the vehicle starts traveling and the in-vehicle apparatus starts navigation.

Therefore, the in-vehicle apparatus stores the data of a direction in which the vehicle heads (hereinafter referred to as direction data) when a user ends the using of the vehicle. When the user starts using the vehicle, the direction data stored is used for displaying the vehicle location mark on the display. This technology is called “last memory technology.” In addition to the “last memory technology,” the laid-open application publication No. 2007-93373 discloses a technology that a user himself/herself sets direction data when the user starts using the vehicle.

On the other hand, improved functions of mobile terminals, such as cellular phones and PDAs (Personal Digital Assistant) allow a navigation system to be implemented on the mobile terminals, with the use of GPS. Moreover, a navigation system in which data required for navigation is provided from a server and a mobile terminal for the in-vehicle apparatus (generally called mobile-terminal-link navigation system) is implemented on the mobile terminals.

However, if the last memory technology or the above-mentioned proposals are adopted for the mobile-terminal-link navigation system without careful consideration, a user may find the mobile-terminal-link navigation system inconvenient to use. That problem is explained concretely.

If the mobile-terminal-link navigation system adopts the technology that uses direction data stored in a mobile terminal at the end of using the vehicle by a user to display guiding information on the display at the start of using the vehicle by a user, a problem may arise. One example of cases where a problem arises is when a different user uses a mobile terminal other than the mobile terminal in which the direction data was last stored. In that case, the direction data stored cannot be used for the guidance information displayed at the start of using the vehicle because the direction data is not stored in that mobile terminal.

Moreover, if the above-mentioned technology proposed is adopted for the mobile-terminal-link navigation system, there arises a problem that a user needs to set direction data.

### SUMMARY OF THE INVENTION

According to one aspect of this invention, a navigation system includes an in-vehicle apparatus for installation in a vehicle, and a data providing apparatus for providing navigation data for the in-vehicle apparatus. In the navigation system, the data providing apparatus includes an obtaining part that obtains from the in-vehicle apparatus first direction data which represents a direction in which the vehicle heads at a start of providing the navigation data, a deriving part that derives second direction data which represents the direction in which the vehicle heads based on a change of a location of the vehicle after a start of traveling of the vehicle, a first transmitting part that transmits to the in-vehicle apparatus the navigation data in accordance with the direction in which the vehicle heads; and a second transmitting part that transmits to the in-vehicle apparatus the second direction data derived by the deriving part. The in-vehicle apparatus includes a display part that displays the navigation data which is received from the data providing apparatus, a storage part that stores during a stop of working of the in-vehicle apparatus the second direction data received from the data providing apparatus, and a third transmitting part that transmits the second direction data which is stored in the storage part, to the data providing apparatus as the first direction data after activation of the in-vehicle apparatus.

The data providing apparatus included in the navigation system obtains the direction in which the vehicle heads, from the in-vehicle apparatus, and uses the direction for the navigation data which is provided for the in-vehicle apparatus when providing the navigation data. The in-vehicle apparatus included in the navigation system transmits the direction data stored in the storage part to the data providing apparatus after activation of the in-vehicle apparatus. Therefore, even when a different user uses a different mobile terminal, the direction data can be used to display route guidance on the in-vehicle apparatus.

According to another aspect of this invention, the navigation data provides route guidance leading to a destination for a user and the second transmitting part transmits the second direction data to the in-vehicle apparatus at an end of the route guidance.

The data providing apparatus included in the navigation system transmits the direction data to the in-vehicle apparatus at the end of the route guidance when the route guidance to a destination is provided for the user. Therefore, the navigation system can store, in the in-vehicle apparatus, the data of the direction in which the vehicle is parked at the end of the using of the vehicle by the user, and can use the direction data when the user restarts using the vehicle.

According to another aspect of this invention, the in-vehicle apparatus further includes a detection part that detects a travel mode of the vehicle and the second transmitting part transmits the second direction data to the in-vehicle apparatus when a stop of traveling of the vehicle is detected.

The data providing apparatus included in the navigation system transmits the direction data to the in-vehicle apparatus when the vehicle stops traveling. Therefore, the in-vehicle apparatus included in the navigation system can store the data of the direction in which the vehicle heads when the user ends the using of the vehicle before arriving at a destination and the route guidance is ended before guiding the user to the destination, and can allow the user to use the direction data when the user restarts using the vehicle.

Therefore, an object of the invention is to provide a technology that is capable of automatically using correct direction data to display guidance immediately after activation of the in-vehicle apparatus.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows a configuration of a navigation system;

FIG. 2 is a system block diagram of a vehicle;

FIG. 3 is a system block diagram of a mobile terminal;

FIG. 4 is a system block diagram of a server;

FIG. 5 is a flow diagram explaining control of a navigation system;

FIG. 6 is a flow diagram explaining control of a navigation system;

FIG. 7 shows a guidance image by a navigation system;

FIG. 8 is a flow diagram explaining control of a navigation system;

FIG. 9 shows a guidance image by a navigation system;

FIG. 10 is a flow diagram explaining control of a navigation system; and

FIG. 11 shows a guidance image by a navigation system.

### DESCRIPTION OF THE EMBODIMENTS

Hereafter, an embodiment of the invention is described with reference to the accompanying drawings.

### Exemplary Embodiment

### Mobile-Terminal-Link Navigation System

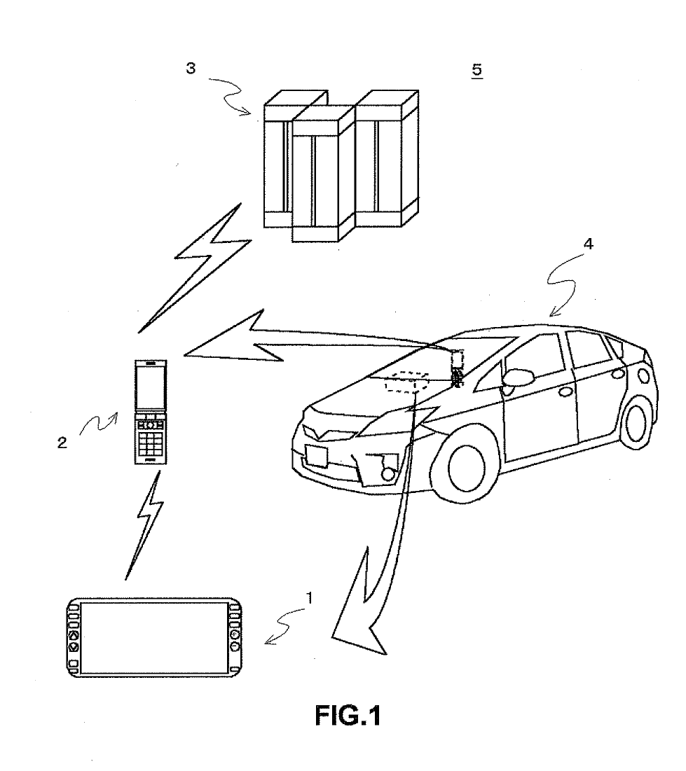

FIG. 1 shows a configuration of a mobile-terminal-link navigation system 5 that is an exemplary embodiment of the invention. The mobile-terminal-link navigation system 5 includes an in-vehicle apparatus 1 for installation in a vehicle, such as a car, a mobile terminal 2 that is a data providing apparatus, and a server 3. The in-vehicle apparatus 1 communicates with the mobile terminal 2, for example, via near field communication based on Bluetooth (registered trademark) standard, and transmits and receives navigation data and the like. For the communication, cable communication, such as communication by USB connection, may be used. The mobile terminal 2 communicates with the in-vehicle apparatus 1 via near field communication, and transmits and receives the navigation data and the like. Moreover, the mobile terminal 2 receives data, etc. for measuring a current location via wireless communication with GPS satellites. Furthermore, the mobile terminal 2 communicates with the server 3 wirelessly, and transmits and receives navigation data, etc. The GPS satellites communicate wirelessly with the mobile terminal 2 and transmit the data, etc. for measuring the current location. The server 3 communicates wirelessly with the mobile terminal 2, and transmits and receives navigation data, etc. The in-vehicle apparatus 1, the mobile terminal 2, and the server 3 included in the mobile-terminal-link navigation system 5 implement a navigation function described later.

In the mobile-terminal-link navigation system 5 that is an embodiment of this invention, the mobile terminal 2 works with the server 3 to provide the navigation data for the in-vehicle apparatus 1. Therefore, a combination of the mobile terminal 2 and the server 3 may be regarded as a data providing apparatus that provides the navigation data for the in-vehicle apparatus 1.

(System Block Diagram)

(In-Vehicle Apparatus)

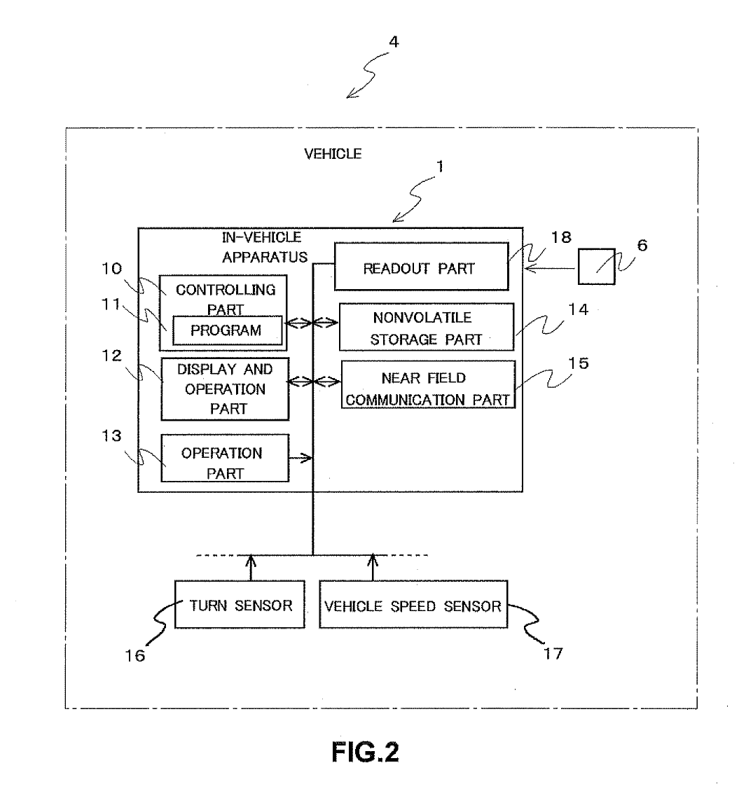

FIG. 2 is a system block diagram of the in-vehicle apparatus 1. The in-vehicle apparatus 1 includes a controlling part 10, a display and operation part 12, an operation part 13, a nonvolatile storage part 14, a near field communication part 15, a readout part 18, a sound output part, an input-and-output part, etc.

The controlling part 10 implements various types of control so that the navigation function, a music playback function, etc can be performed.

The display and operation part 12 receives a user operation while displaying the navigation data (such as a guidance image used as guidance display for guiding a user to a destination by displaying a highlighted route).

The operation part 13 receives a user operation other than the user operation received by the display and operation part 12.

The nonvolatile storage part 14 stores data required for control. The nonvolatile storage part 14 may be, for example, a flash memory.

The near field communication part 15 communicates with a communication part, device, or the like located within a predetermined distance, e.g., 10 m to 100 m in radius, in accordance with the Bluetooth (registered trademark) standard. The sound output part outputs music, an operation sound produced for each operation, etc.

The input-and-output part is FF. The input-and-output part receives signals via in-vehicle network (e.g., Control Area Network) from a turn sensor 16 (e.g., gyroscope) that detects a turn of the vehicle and a vehicle speed sensor 17 that detects a traveling speed of the vehicle, etc. The turn sensor 16 and the vehicle speed sensor 17 are external apparatuses installed in the vehicle separately from the in-vehicle apparatus 1.

When the navigation function is performed, the navigation data is displayed on the display and operation part 12. Moreover, the near field communication part 15 receives the navigation data such as the guidance image provided from the mobile terminal 2. Moreover, the near field communication part 15 transmits the navigation data to be transmitted to the mobile terminal 2 from the in-vehicle apparatus 1.

The controlling part 10 includes a microcomputer including a CPU and the like. The controlling part 10 performs a function relating to a navigation system by an arithmetic processing that the CPU performs according to a program 11 stored in a predetermined memory (e.g., a ROM) that is a recording medium.

The program 11 stored in a memory card 6 that is non-transitory computer-readable may be obtained by reading-out by a readout part 18. Moreover, the program may be updated such as by communicating with an external server.

Moreover, the following (A) and (B) are main navigation functions performed by the controlling part 10.

(A) A near field communication function in which the controlling part 10 transmits and receives data to/from the mobile terminal 2 via the near field communication part 15.

(B) A display function in which the controlling part 10 displays the navigation data being received on the display and operation part 12.

Details of these functions are described later.

Moreover, the controlling part 10 controls each part of the in-vehicle apparatus 1 to execute steps for the navigation function mentioned later.

(Mobile Terminal)

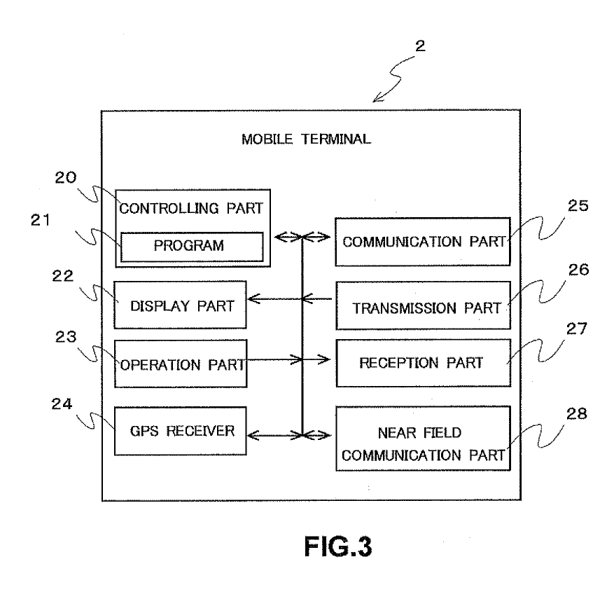

FIG. 3 is a system block diagram of the mobile terminal 2. The mobile terminal 2 includes a controlling part 20, a display part 22, an operation part 23, a GPS receiver 24, a communication part 25, a transmission part 26, a reception part 27, a near field communication part 28, and a storage part, etc.

The controlling part 20 implements various types of control in order to perform a telephone function, the navigation function, etc.

The display part 22 displays a telephone number, etc. during a conversation on the mobile terminal 2.

The operation part 23 receives a user operation.

The GPS receiver 24 receives signals transmitted from the GPS satellites.

The communication part 25 transmits and receives the navigation data to/from the server via wireless communication, as well as conversation data for conversation to/from another mobile terminal.

The transmission part 26 inputs sound of a telephone conversation with a person on the other side of a telephone line during the telephone conversation.

The reception part 27 outputs the sound of the telephone conversation with the person on the other side of the telephone line during the telephone conversation.

The near field communication part 28 communicates with a communication part, device, or the like located within a predetermined distance, e.g., 10 m to 100 m in radius, in accordance with the Bluetooth (registered trademark) standard.

The storage part stores data required for control. The storage part may be, for example, a flash memory.

The mobile-terminal-link navigation system 5 that is an embodiment of this invention works when a user (a driver of the vehicle) carries the mobile terminal 2 with himself/herself. Therefore, the mobile terminal 2 is located in the vehicle, and current location data obtained by the GPS receiver 24 of the mobile terminal 2 is the same as the vehicle current location data.

The controlling part 20 includes a microcomputer including a CPU and the like. The controlling part 20 performs a function relating to the navigation system by an arithmetic processing that the CPU performs according to a program 21 stored in a predetermined memory (e.g., a ROM). The program 21 is stored in a predetermined memory. However, the program 21 may be updated such as by communication with an external server and reading-out from a recording medium storing a program.

Moreover, the following (C), (D), (E) and (F) are main navigation functions that the controlling part 20 performs.

(C) A near field communication function in which the controlling part 20 transmits and receives data to/from the in-vehicle apparatus 1 via the near field communication part 28.

(D) A second data generating function that generates second data that is the guidance image able to be displayed on the display and operation part 12 of the in-vehicle apparatus 1, from first data that is data relating to a vicinity of a route (hereinafter referred to as route vicinity data) received from the server 3.

Here, the route vicinity data refers to data and location data of a facility (e.g., a convenience store, a gas station, a fast-food shop, a supermarket, a department store, a public facility such as a waterworks department and a station, etc.), and a road, a river, the sea, etc.

(E) A route matching function in which the controlling part 20 corrects the current location data to be displayed on an appropriate point on the guidance image.

(F) A direction derivation function in which the controlling part 20 derives data of a direction in which a vehicle 4 heads (hereinafter referred to as direction data) after the vehicle 4 starts traveling, based on a change of a location of the vehicle 4.

Details of these functions are described later.

Moreover, the controlling part 20 controls each part of the mobile terminal 2 to execute steps for the navigation function described later.

(Server)

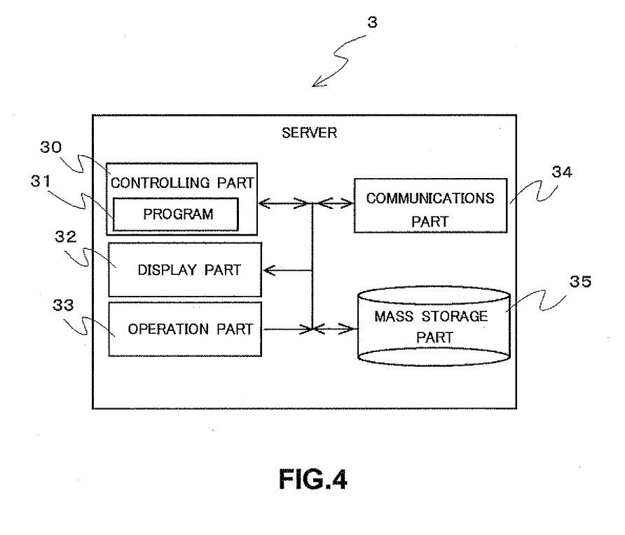

FIG. 4 is a system block diagram of the server 3. The server 3 includes a controlling part 30, a display part 32, an operation part 33, a communication part 34, a mass storage part 35, etc.

The controlling part 30 implements various types of control to perform a contents provision function for providing contents such as navigation data.

The display part 32 displays a setting screen, a maintenance screen, etc.

The operation part 33 receives an operation made by an administrator who implements settings required for control, performs maintenance of a control program and control data, etc.

The communication part 34 transmits and receives the navigation data and the like to/from the mobile terminal 2 via wireless communication.

The mass storage part 35 stores the navigation data, e.g., the guidance image.

Moreover, the controlling part 30 includes a microcomputer including a CPU and the like. The controlling part 30 performs a function relating to the navigation system by an arithmetic processing that the CPU performs according to a program 31 stored in a predetermined memory (ROM).

The following (G) and (H) are main navigation functions performed by the controlling part 30.

(G) A route generation function in which the controlling part 30 generates a route based on the current location data of the vehicle, destination data, and the direction data.

(H) A first data extraction function in which the controlling part 30 extracts the first data that is the data relating to a vicinity of a route generated, from data stored in the mass storage part 35.

Details of these functions are described later.

Moreover, the controlling part 30 controls each part of the server 3 to execute steps for the navigation function described later.

<Navigation Process>

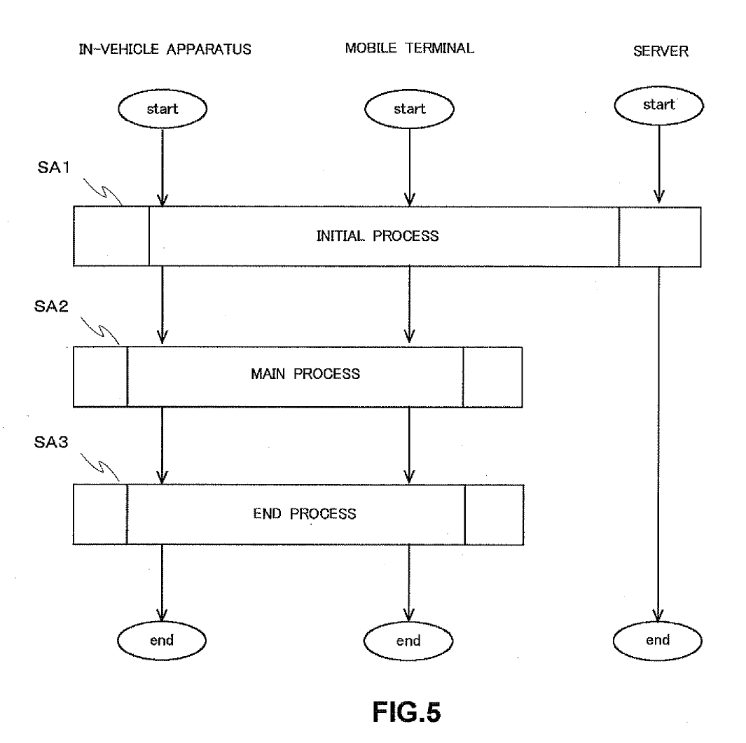

A navigation process executed in the mobile-terminal-link navigation system 5 is explained with reference to FIG. 5. The navigation process includes an initial process, a main process, and an end process. When a user carrying the mobile terminal 2 in the vehicle 4 activates the in-vehicle apparatus 1 by turning on an ACC switch in the vehicle 4, the navigation process shown in FIG. 5 starts in the mobile-terminal-link navigation, system 5. By the start, the navigation process moves to a step SA1.

In the step SA1, the in-vehicle apparatus 1, the mobile terminal 2, and the server 3 perform the initial process. The initial process is required to be performed before a start of the main process in the navigation process by linking with a mobile terminal. The initial process includes establishment of communications, and process of transmission and reception of necessary data mutually. Then the navigation process moves to a step SA2.

In the step SA2, the in-vehicle apparatus 1 and the mobile terminal 2 execute the main process. In the navigation process by linking with a mobile terminal, the main process means guiding a user to a destination. Then the navigation process moves to a step SA3.

In the step SA3, the in-vehicle apparatus 1 and the mobile terminal 2 execute the end process. In the navigation process by linking with a mobile terminal, the end process is a process in which a parameter is generated to be used next in the navigation process by linking with a mobile terminal. Then the mobile-terminal-link navigation system is ended. The individual processes of the navigation process are described in detail below.

(Initial Process)

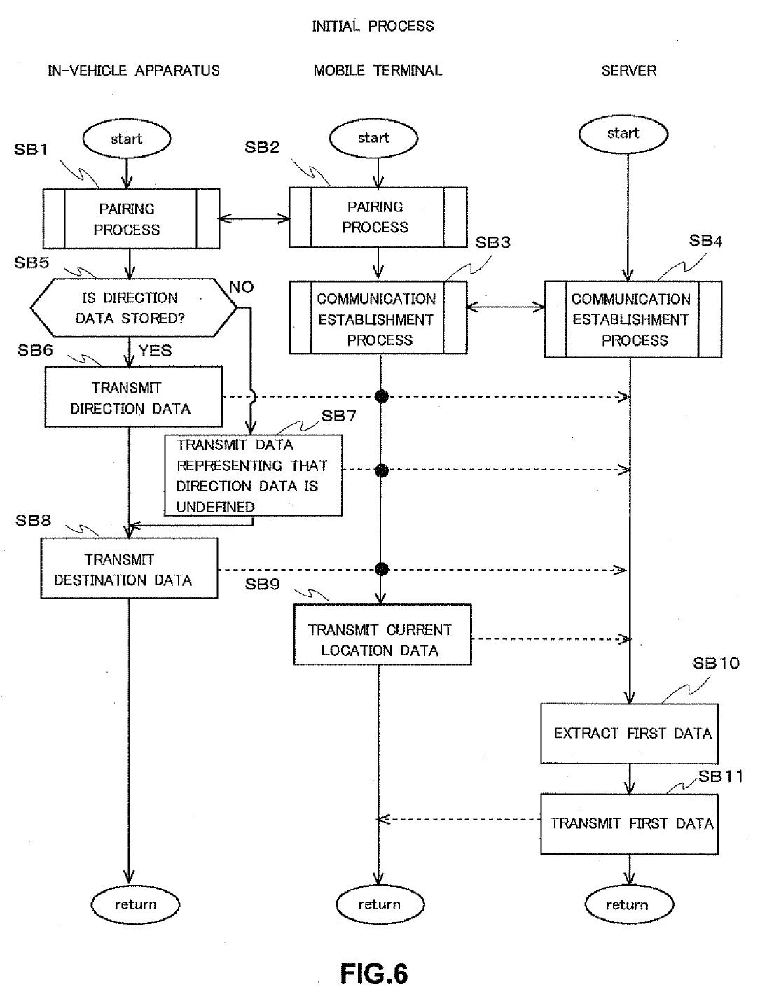

The initial process of the navigation process by linking with a mobile terminal is explained with reference to FIG. 6.

In a step SB1, the controlling part 10 of the in-vehicle apparatus 1 executes a pairing process to be paired with the mobile terminal 2 via near field communication. The term pairing refers to implementing a setup relating to communication of an apparatus/a part to communicate with each other via near field communication. For example, in the pairing process, the setup is implemented for mutual recognition between the in-vehicle apparatus 1 and the mobile terminal 2, as a communication partner, which mutually transmit and receive data being required for performing the mobile-terminal-link navigation. Then the initial process moves to a step SB2.

In the step SB2, the controlling part 20 of the mobile terminal 2 executes the pairing process to be paired with the in-vehicle apparatus 1 via near field communication. Then the initial process moves to a step SB3.

In the step SB3, the controlling part 20 of the mobile terminal 2 establishes communication with the server 3 via wireless communication. Like the pairing process mentioned above, the setup is implemented for mutual recognition between the mobile terminal 2 and the server 3, as a communication partner, which mutually transmits and receives data being required for performing the mobile-terminal-link navigation. Then the initial process moves to a step SB4.

In the step SB4, the controlling part 30 of the server 3 establishes communication with the mobile terminal 2 via wireless communication. Like the pairing process mentioned above, the setup is implemented for mutual recognition between the mobile terminal 2 and the server 3, as a communication partner, which mutually transmits and receives data being required for performing the mobile-terminal-link navigation. Then the initial process moves to a step SB5.

In the step SB5, the controlling part 10 of the in-vehicle apparatus 1 determines whether the direction data is stored in the nonvolatile storage part 14. When the controlling part 10 determines that the direction data is stored in the nonvolatile storage part 14 (YES in the step SB5), the initial process moves to a step SB6. When the controlling part 10 determines that the direction data is not stored in the nonvolatile storage part 14 (NO in the step SB5), the initial process moves to a step SB7.

In the step SB6, the controlling part 10 of the in-vehicle apparatus 1 transmits the direction data stored in the nonvolatile storage part 14 to the mobile terminal 2, and the controlling part 20 of the mobile terminal 2 forwards the data to the server 3.

In the step SB7, the controlling part 10 of the in-vehicle apparatus 1 transmits data being stored in the nonvolatile storage part 14 and representing that a direction in which the vehicle 4 heads is undefined, to the mobile terminal 2. The controlling part 20 of the mobile terminal 2 forwards the data to the server 3.

In a step SB8, the controlling part 10 of the in-vehicle apparatus 1 transmits data of a destination being set by the user using the display and operation part 12, to the mobile terminal 2. The controlling part 20 of the mobile terminal 2 forwards the destination data to the server 3.

A destination may be set by a user operation made with the operation part 23 of the mobile terminal 2. In that case, the controlling part 20 of the mobile terminal 2 transmits the data of the destination being set by the user, to the server 3.

In a step SB9, the controlling part 20 of the mobile terminal 2 transmits the current location data computed on the basis of GPS signals received by the GPS receiver 24, to the server 3.

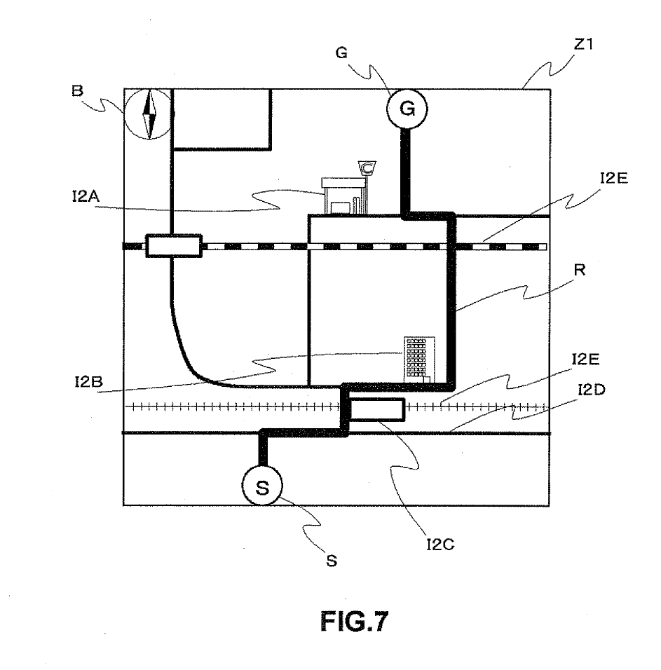

In a step SB10, the controlling part 30 of the server 3 generates a route based on the current location data, the direction data, and the destination data. The controlling part 30 extracts a first data Z1 that is the route vicinity data, from the mass storage part 35. The method in which the controlling part 30 generates a route is explained with reference to FIG. 7. Based on the data mentioned above, the controlling part 30 generates a route, like a route R shown in FIG. 7, leading to a destination G, from a direction represented by the direction data (in a northerly direction, based on a bearing indicator B on the map in FIG. 7) at a current location S. In other words, the direction data does not allow a route to be generated from a rear end of a vehicle leading to the destination G. Next, the first data Z1 that is the route vicinity data is extracted from the data stored in the mass storage part 35. Then the initial process moves to a step SB11.

In the step SB11, the controlling part 30 of the server 3 transmits the first data Z1 extracted to the mobile terminal 2. It is the end of the initial process and the process moves to the main process.

(Main Process)

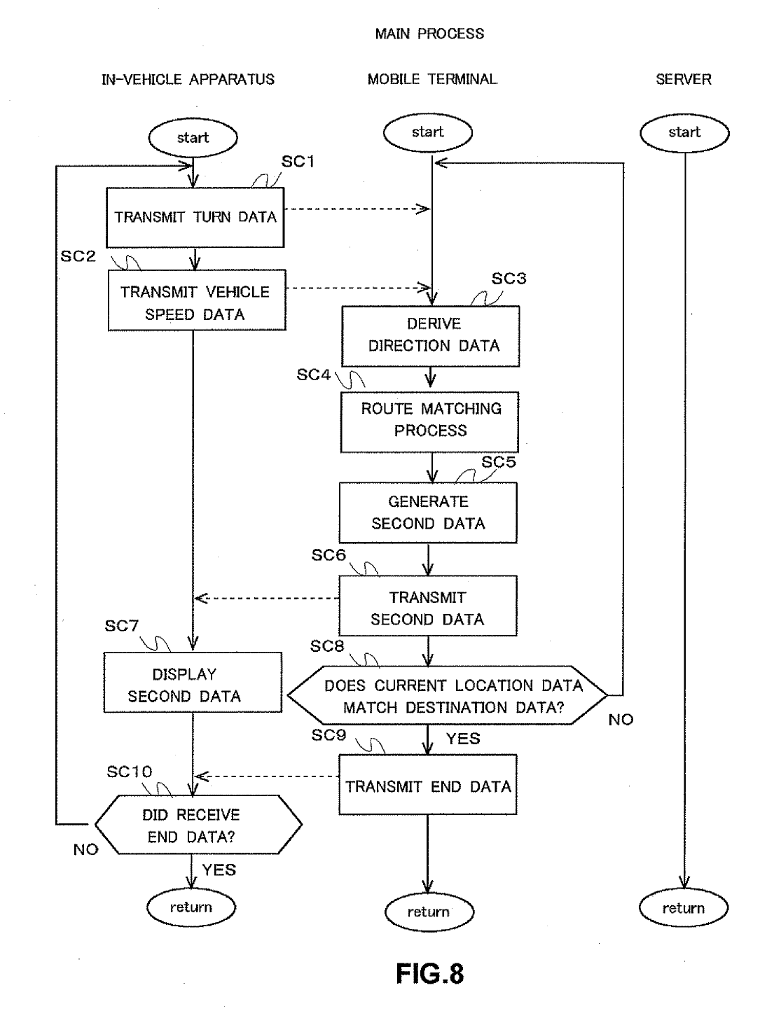

The main process of the navigation process by linking with a mobile terminal is described with reference to FIG. 8.

In a step SC1, the controlling part 10 of the in-vehicle apparatus 1 receives an angle signal representing a turn of the vehicle 4, from the turn sensor 16 and transmits the angle signal received to the mobile terminal 2 via the in-vehicle network. Then the main process moves to a step SC2.

In the step SC2, the controlling part 10 of the in-vehicle apparatus 1 receives a speed signal from the vehicle speed sensor 17 and transmits the speed signal received to the mobile terminal 2 via the in-vehicle network. Then the main process moves to a step SC3.

In the step SC3, the controlling part 20 of the mobile terminal 2 derives the direction data based on a change of a location of the vehicle 4 after the vehicle 4 starts traveling. In other words, the controlling part 20 derives a track of the vehicle 4, based on the current location data and the angle signal received from the in-vehicle apparatus 1, and further derives a direction in which the vehicle 4 heads by deriving a travel direction from the track of the vehicle 4. Moreover, the controlling part 20 may derive the direction data by adding an amount of angle change to the direction data that has been obtained already, based on the angle signal received.

The controlling part 20 is not capable of deriving the direction data until the vehicle 4 travels a certain distance. Therefore, when the vehicle 4 starts traveling, the controlling part 20 uses the direction data received from the in-vehicle apparatus 1 in the initial process, without deriving the direction data. Then the main process moves to a step SC4.

In the step SC4, the controlling part 20 of the mobile terminal 2 executes a route matching process based on the current location data and data of roads included in the first data Z1.

When the current location data is compared to the data of roads included in the first data Z1, there is a case where the current location data does not match location data of roads included in the first data Z1 because GPS data is not so accurate. The term route matching refers to a correction to logically match the current location data with the location data of roads in a case of mismatch of those data.

Concretely, in the case of mismatch mentioned above, the controlling part 20 of the mobile terminal 2 derives the track of the vehicle 4 based on the current location data and the vehicle speed data and the turn data received from the in-vehicle apparatus 1, and determines that a road closely resembling the track computed is the road on which the vehicle 4 travels. The controlling part 20 of the mobile terminal 2 corrects the current location data on the assumption that the vehicle 4 travels on the road. The main process moves to a step SC5.

In the step SC5, the controlling part 20 of the mobile terminal 2 generates data in a size suitable for displaying on the display and operation part 12 of the in-vehicle apparatus 1, from the first data Z1. In other words, the controlling part 20 generates a second data Z2 based on the first data Z1.

A concrete method in which the controlling part 20 generates the second data Z2 from the first data Z1 is explained.

The controlling part 20 generates the second data Z2 to be displayed on the display and operation part 12 of the in-vehicle apparatus 1, based on the current location data and the route vicinity data (e.g., data and location data of a convenience store I2A, a building I2B, a station I2C, a road I2D, a train track I2E, etc. shown in FIG. 7) that is the first data Z1. Moreover, the controlling part 20 generates a predetermined number of pieces (e.g., three pieces) of the second data Z2 to be displayed in a manner where the vehicle 4 heads upward on the display and operation part 12, based on the direction data.

In other words, the controlling part 20 generates the second data Z2 for displaying a vehicle mark A at a location slightly lower than a center of a display screen of the display and operation part 12 in a manner where the vehicle location mark A moves upward. Moreover, the controlling part 20 extracts facilities and the like located in a predetermined distance ahead (e.g. in 300 m), from the first data Z1, based on the current location data and the direction data, and adds the facilities and the like extracted to the second data Z2.

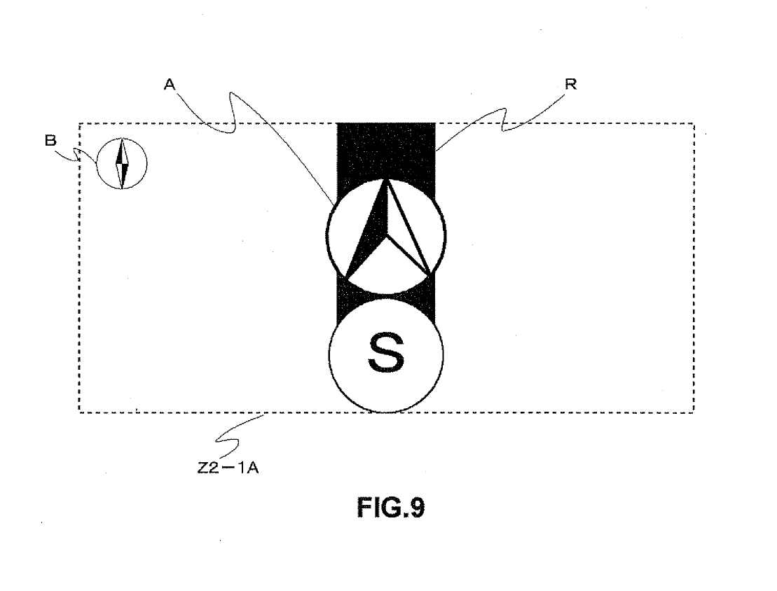

Furthermore, among the second data Z2 generated, the controlling part 20 uses the direction data received from the in-vehicle apparatus 1 in the initial process, as a base of initial second data Z2-1A which is displayed at a start of the route guidance, as shown in FIG. 9. The controlling part 20 uses the direction data derived in the step SC3, as a base for the second data Z2 other than the initial second data Z2-1A.

Moreover, a method in which the controlling part 20 shows a direction using the vehicle location mark A, is concretely explained. As shown in FIG. 9, on the initial second data Z2-1A displayed at a start of the route guidance, the controlling part 20 displays an acute-angle arrowhead of the vehicle location mark A which is encircled by a circle, to point a traveling direction of the vehicle 4.

Thereby, the user can understand a direction in which the vehicle 4 is heading by the second data Z2 displayed initially on the display and operation part 12 of the in-vehicle apparatus 1 and can expect a direction in which the vehicle location mark A will move on the route R.

The in-vehicle apparatus 1 displays the vehicle location mark A in the same method mentioned above on the second data Z2 other than the initial second data Z2-1A.

Moreover, a reason why the controlling part 20 of the mobile terminal 2 generates only the predetermined pieces of the second data Z2 is because all pieces of the second data Z2 leading to the destination, even if generated, may not be used due to deviation of the vehicle 4 from the route R being set. When the vehicle 4 deviates from the route R being set, the mobile-terminal-link navigation system 5 repeats the initial process from the step SB9 (executes a rerouting process). Then the main process moves to a step SC6.

In the step SC6, the controlling part 20 of the mobile terminal 2 transmits the predetermined pieces of the second data Z2 to the in-vehicle apparatus 1. Timing when the controlling part 20 transmits the second data Z2 is determined according to the vehicle speed signal transmitted from the in-vehicle apparatus 1. For example, when receiving the vehicle speed signal representing 40 km/h, the controlling part 20 shortens a cycle of transmitting the second data Z2 because the vehicle 4 travels at a high speed and the controlling part 20 needs to transmit much of the second data Z2. On the other hand, when receiving the vehicle speed signal representing 10 km/h, the controlling part 20 lengthens the cycle for transmitting the second data Z2 because the vehicle 4 travels at a low speed and the controlling part 20 needs to transmit a little of the second data Z2. Then the main process moves to a step SC7.

In the step SC7, the controlling part 10 of the in-vehicle apparatus 1 updates and displays the second data Z2 on the display and operation part 12 in order of receiving of the second data Z2, and erases previous second data Z2 from a predetermined storage part. The controlling part 10 of the in-vehicle apparatus 1 prevents a delay of displaying the second data Z2 updated, by holding the predetermined pieces of the second data Z2 received from the mobile terminal 2. Then the main process moves to a step SC8.

In the step SC8, the controlling part 20 of the mobile terminal 2 determines whether the current location data matches location data representing the destination. When judging that the current location data matches the location data representing the destination (YES in the step SC8), the main process moves to a step SC9. When judging that the current location data does not match the location data representing the destination (NO in the step SC8), the main process moves back to the step SC 1.

In other words, the controlling part 20 of the mobile terminal 2 constantly implements the route matching and generates the predetermined pieces of the second data Z2 from the first data Z1 until the vehicle 4 arrives at the destination and the route guidance ends. The controlling part 20 repeats a procedure for transmitting the second data Z2 added with the vehicle location mark A indicating a direction in which the vehicle 4 heads, to the in-vehicle apparatus 1. Then the main process moves to a step SC9.

In the step SC9, the controlling part 20 of the mobile terminal 2 transmits data representing an end of the route guidance (hereinafter referred to as end data), to the in-vehicle apparatus 1. Then the main process moves to a step SC 10.

In the step SC 10, the controlling part 10 of the in-vehicle apparatus 1 determines whether or not the controlling part 10 of the in-vehicle apparatus 1 has received the end data from the mobile terminal 2. When the controlling part 10 of the in-vehicle apparatus 1 determines that the end data has been received (YES in the step SC10), the main process ends. When the controlling part 10 of the in-vehicle apparatus 1 determines that the end data has not been received (NO in the step SC10), the main process moves back to the step SC3.

In other words, after the vehicle 4 arrives at the destination and the mobile-terminal-link navigation system 5 ends the route guidance, the controlling part 20 of the mobile terminal 2 transmits the end data to the in-vehicle apparatus 1. Therefore, the controlling part 10 of the in-vehicle apparatus 1 updates and displays the second data Z2 on the display and operation part 12 in order of receiving of the second data Z2. When receiving the end data the controlling part 10 of the in-vehicle apparatus 1 ends the updating and stops the displaying of the second data Z2. The main process ends here and moves to the end process.

(End Process)

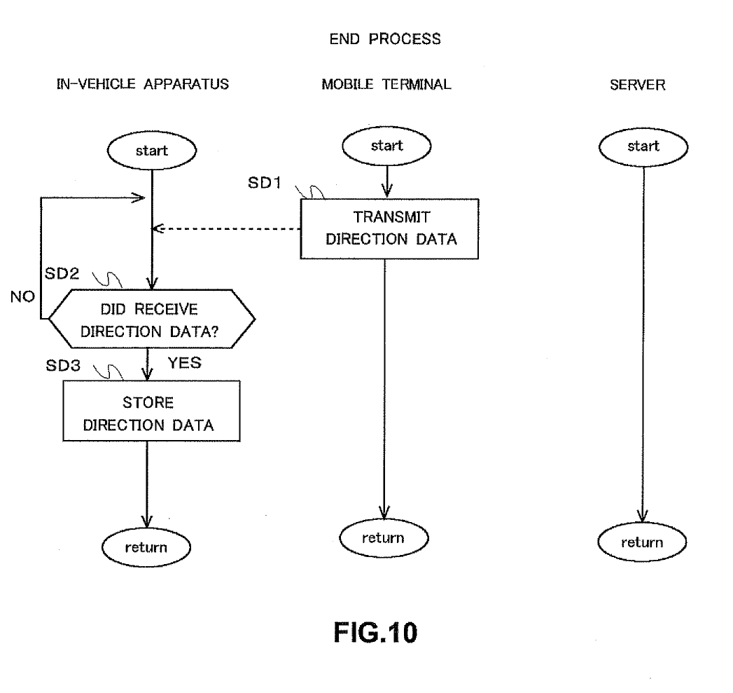

The end process of the navigation system by linking with a mobile terminal is explained with reference to FIG. 10.

In a step SD1, the controlling part 20 of the mobile terminal 2 transmits, to the in-vehicle apparatus 1, the direction data derived in the step SC3 prior to the SC8 in the main process, where the current location data is determined to accord with the destination data.

There is a case that the controlling part 20 of the mobile terminal 2 is unable to derive the direction data. In such a case, data representing that a direction in which the vehicle 4 heads is undefined is set as the direction data. Examples of the case where the mobile terminal 2 is unable to derive the direction data are the cases it is difficult to determine the direction in which the vehicle 4 heads because the vehicle 4 is located in an area where receiving of GPS signals is difficult, at a timing of the deriving the direction data. Then the end process moves to a step SD2.

In the step SD2, the controlling part 10 of the in-vehicle apparatus 1 determines whether or not the controlling part 10 of the in-vehicle apparatus 1 has received the direction data from the mobile terminal 2. When the controlling part 10 of the in-vehicle apparatus 1 determines to have received the direction data, the end process moves to a step SD3. When the controlling part 10 of the in-vehicle apparatus 1 determines to have not received the direction data, the end process returns to a step earlier than the step SD2. In other words, the step SD2 is repeated in a predetermined cycle. Then the end process moves to the step SD3.

In the step SD3, the controlling part 10 of the in-vehicle apparatus 1 stores the direction data received on the nonvolatile storage part 14.

In other words, in the end process, the controlling part 10 of the in-vehicle apparatus 1 stores the direction data received from the mobile terminal 2 at an end of the route guidance, to the nonvolatile storage part 14. Therefore, the mobile-terminal-link navigation system 5 can store the direction data while the in-vehicle apparatus 1 stops working. As a result, when the user starts using the vehicle 4 next, the in-vehicle apparatus 1 can use the direction data stored in the nonvolatile storage part 14 for the mobile-terminal-link navigation, in the initial process that starts after activation of the in-vehicle apparatus 1.

More concretely, when the user starts using the vehicle 4 next, the vehicle 4 is parked in a same direction in which the user last parked the vehicle 4 when he/she ended the using of the vehicle 4, unless there is a special reason. An example of the special reason is that the vehicle 4 is loaded and turned on a vehicle turntable in a multi-level parking lot or is loaded on a vessel.

Therefore, the mobile-terminal-link navigation system 5 presumes that the user ends the using of the vehicle 4 from an end of the route guidance, and the in-vehicle apparatus 1 stores the direction data at the end of the route guidance. When the user uses the mobile-terminal-link navigation system 5 next, the mobile-terminal-link navigation system 5 uses the direction data stored to indicate the vehicle location mark A on the initial navigation data displayed on the display and operation part 12. Therefore, the user can predict a direction in which the vehicle location mark A displayed moves. (Actually the vehicle location mark A is fixed. The vehicle location mark A is displayed as if the mark itself moved.) As a result, the confusion mentioned above can be avoided. The main process is ended here.

<Modification>

Although an embodiment of this invention has been explained, this invention is not limited to the embodiment mentioned above, and various modifications are possible. Modification examples are explained below. Moreover, the modifications described below may be combined arbitrarily.

<Modification 1>

In the step SC8 in the exemplary embodiment mentioned above, it is explained as follows. “The controlling part 20 of the mobile terminal 2 determines whether or not the current location data matches the location data representing the destination. When the current location data is determined to match the location data representing the destination (YES in the step SC8), the main process moves to the step SC9. In the step SC9, the controlling part 20 of the mobile terminal 2 transmits data representing that the route guidance is ended, to the in-vehicle apparatus 1.” However, the controlling part 20 of the mobile terminal 2 may determine shortly before the step SC8 whether or not the vehicle 4 is stopping, and then the controlling part 20 of the mobile terminal 2 may transmit the direction data to the in-vehicle apparatus 1 and the direction data transmitted is stored in the in-vehicle apparatus 1 when the controlling part 20 of the mobile terminal 2 determines that the vehicle 4 is stopping.

In other words, when ending the using of the vehicle 4, the user stops the vehicle 4. Even when the user ends the using of the vehicle 4 before arriving at the destination, the data about the direction in which the vehicle 4 is parked, can be stored in the in-vehicle apparatus 1. Therefore, when the user starts using the vehicle 4, he/she can use the direction data.

<Modification 2>

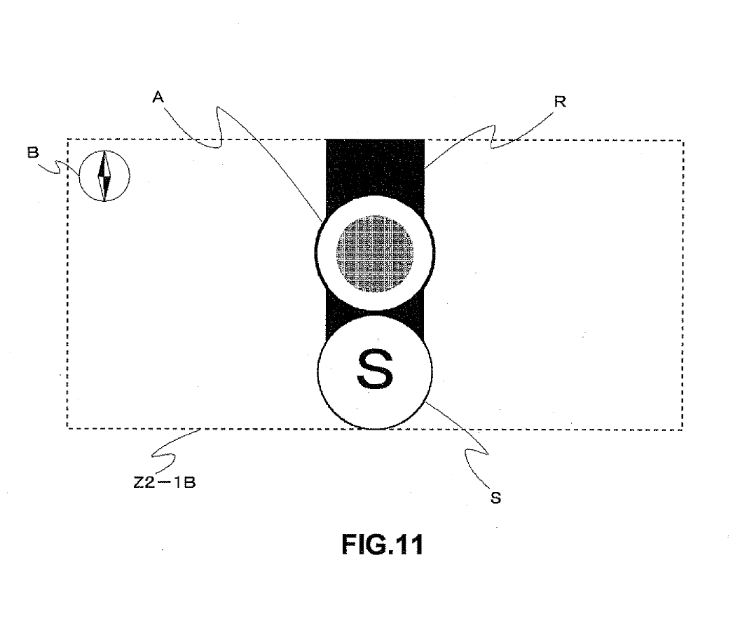

In the step SC5 in the description of the exemplary embodiment mentioned above, it is explained that “as shown in FIG. 9, on the initial second data Z2-1A displayed at a start of the route guidance, the controlling part 20 displays an acute-angle arrowhead of the vehicle location mark A which is encircled by a circle, to point a traveling direction of the vehicle 4.” However, in the step SB7 of the initial process, when the controlling part 20 of the mobile terminal 2 receives the data representing that a direction in which the vehicle 4 heads is undefined, the vehicle location mark A may be a double circle, as shown in FIG. 11, without an acute-angle arrowhead, representing that a direction in which the vehicle 4 heads is undefined, instead of an encircled arrowhead, on the initial second data Z2-1A displayed on the display and operation part 12. Moreover, in this case, the second data Z2 is clipped to be displayed in north-up status on the display and operation part 12 of the in-vehicle apparatus 1, in the step SC5.

Thereby, the user can understand that data of a direction in which the vehicle 4 heads is undefined for some reason and grasp a direction in which the vehicle 4 heads because the second data Z2 is displayed in north-up status.

Moreover, although, in the embodiment described above, it is explained that various functions are implemented by software performance by arithmetic processing of a CPU according to a program, a part of these functions may be implemented by electric hardware circuitry. Contrarily, a part of the functions are implemented by electric hardware circuitry may be implemented by software performance by arithmetic processing of a CPU according to a program.

Furthermore, in the embodiments described above, each of the control processes is shown and explained in a flow diagram. However, the each of the control processes may be subdivided into multiple sub-processes and the multiple sub-processes subdivided may be performed in parallel by multitasking feature of a controlling part.

While the invention has been shown and described in detail, the foregoing description is in all aspects illustrative and not restrictive. It is therefore understood that numerous other modifications and variations can be devised without departing from the scope of the invention.

What is claimed is:

1. A navigation system comprising:
an in-vehicle apparatus for installation in a vehicle; and
a data providing apparatus for providing navigation data for the in-vehicle apparatus, wherein
the data providing apparatus includes:
an obtaining part that obtains from the in-vehicle apparatus first direction data which represents a direction in which the vehicle heads at a start of providing the navigation data;
a deriving part that derives second direction data which represents the direction in which the vehicle heads based on a change of a location of the vehicle after a start of traveling of the vehicle;
a first transmitting part that transmits to the in-vehicle apparatus the navigation data in accordance with the direction in which the vehicle heads; and
a second transmitting part that transmits to the in-vehicle apparatus the second direction data derived by the deriving part, and
the in-vehicle apparatus includes:
a display part that displays the navigation data which is received from the data providing apparatus;
a storage part that stores during a stop of working of the in-vehicle apparatus the second direction data received from the data providing apparatus; and
a third transmitting part that transmits the second direction data which is stored in the storage part, to the data providing apparatus as the first direction data after activation of the in-vehicle apparatus.

2. The navigation system according to claim 1, wherein
the navigation data provides route guidance leading to a destination for a user, and
the second transmitting part transmits the second direction data to the in-vehicle apparatus at an end of the route guidance.

3. The navigation system according to claim 1, wherein
the in-vehicle apparatus further comprises a detection part that detects a travel mode of the vehicle, and
the second transmitting part transmits the second direction data to the in-vehicle apparatus when a stop of traveling of the vehicle is detected.

4. An in-vehicle apparatus for installation in a vehicle and for display of navigation data provided from a data providing apparatus that (i) transmits to the in-vehicle apparatus the navigation data in accordance with a direction in which the vehicle heads; (ii) obtains from the in-vehicle apparatus first direction data which represents the direction in which the vehicle heads at a start of providing the navigation data; and (iii) derives second direction data which represents a direction in which the vehicle heads on the basis of a change of a location of the vehicle after a start of traveling of the vehicle, the in-vehicle apparatus comprising:
an obtaining part that obtains the second direction data from the data providing apparatus;
a storage part that stores during a stop of working of the in-vehicle apparatus the second direction data which is obtained; and
a transmitting part that transmits the second direction data which is stored in the storage part to the data providing apparatus as the first direction data after activation of the in-vehicle apparatus.

5. A non-transitory computer-readable recording medium that stores a program executable by a computer included in an in-vehicle apparatus for display of navigation data provided from a data providing apparatus that (i) transmits to the in-vehicle apparatus the navigation data in accordance with a direction in which the vehicle heads; (ii) obtains from the in-vehicle apparatus first direction data which represents the direction in which the vehicle heads at a start of providing the navigation data; and (iii) derives second direction data which represents the direction in which the vehicle heads on the basis of a change of a location of the vehicle after a start of traveling of the vehicle, the program causing the computer of the in-vehicle apparatus to execute the steps of
obtaining the second direction data from the data providing apparatus;
storing the second direction data obtained in a storage part of the in-vehicle apparatus during a stop of working of the in-vehicle apparatus; and
transmitting the second direction data stored in the storage part to the data providing apparatus as the first direction data after activation of the in-vehicle apparatus.

6. A navigation method using a navigation system including an in-vehicle apparatus for installation in a vehicle and a data providing apparatus for providing navigation data to the in-vehicle apparatus, the navigation method comprising the steps of:
(a) the data providing apparatus obtaining from the in-vehicle apparatus first direction data which represents a direction in which the vehicle heads at a start of providing of the navigation data;
(b) the data providing apparatus deriving second direction data which represents a direction in which the vehicle heads on the basis of a change of a location of the vehicle after a start of traveling of the vehicle;
(c) the data providing apparatus transmitting to the in-vehicle apparatus the navigation data in accordance with a direction in which the vehicle heads;
(d) the in-vehicle apparatus displaying the navigation data which is received from the data providing apparatus;
(e) the data providing apparatus transmitting the second direction data to the in-vehicle apparatus;
(f) the in-vehicle apparatus storing the second direction data which is received from the data providing apparatus in a storage part during a stop of working of the in-vehicle apparatus; and
(g) the in-vehicle apparatus transmitting the second direction data which is stored in the storage part to the data providing apparatus as the first direction data after activation of the in-vehicle apparatus.

7. The navigation method according to claim 6, wherein
the navigation data provides route guidance leading to a destination for a user, and
in the step (e) the second direction data is transmitted to the in-vehicle apparatus at an end of providing the route guidance.

8. The navigation method according to claim 6 further comprising the step of
(h) detecting a travel mode of the vehicle by the in-vehicle apparatus, wherein
in the step (e) the second direction data is transmitted to the in-vehicle apparatus when a stop of traveling of the vehicle is detected.

9. The navigation system according to claim 1, wherein the data providing apparatus is a mobile terminal.

10. The in-vehicle apparatus according to claim 4, further comprising:
a display part that displays the navigation data which is received from the data providing apparatus.

11. The navigation method according to claim 6, wherein the data providing apparatus is a mobile terminal.
